(19) United States
(12) Patent Application Publication
(10) Pub. No.: US 2014/0293153 A1
(43) Pub. Date: Oct. 2, 2014

(54) TOUCH PANEL AND METHOD FOR MANUFACTURING THE SAME

(71) Applicant: ETURBOTOUCH TECHNOLOGY INC., Zhongli City (TW)

(72) Inventors: Kuei-Ching WANG, Longtan Township (TW); Ta-Hu LIN, Taipei City (TW)

(73) Assignee: ETURBOTOUCH TECHNOLOGY INC., Zhongli City (TW)

(21) Appl. No.: 14/072,848

(22) Filed: Nov. 6, 2013

(30) Foreign Application Priority Data
Mar. 26, 2013 (TW) 102110667

(51) Int. Cl. G06F 1/16

(52) U.S. Cl. CPC G06F 1/16
USPC 349/12; 29/622

(57) ABSTRACT

A touch panel and a method of manufacturing the same are introduced. The method includes forming a first conductive layer having a first pattern group on a substrate; defining a first region and a second region on the first conductive layer, the first region having a portion of the first pattern group, and the second region having the other portion of the first pattern group; forming the dielectric layer on the first pattern group in the second region; forming a second conductive layer having a second pattern group on the dielectric layer; forming a metal layer on the first pattern group in the first region to produce a first electrode; and forming the metal layer on a portion of the second pattern group to produce a second electrode. The method is simple and conducive to yield improvement and cost reduction.

### CROSS-REFERENCE TO RELATED APPLICATION

This non-provisional application claims priority under 35 U.S.C. §119(a) on Patent Application No(s). 102110667 filed in Taiwan, R.O.C. on Mar. 26, 2013, the entire contents of which are hereby incorporated by reference.

### FIELD OF TECHNOLOGY

The present invention relates to touch panel manufacturing, and more particularly, to a touch panel and a touch panel manufacturing method which are conducive to simplifying the manufacturing process thereof and cutting the manufacturing costs thereof.

### BACKGROUND

Due to the increasingly advanced application of touch panels, a conventional touch panel essentially comes in various types, namely a resistive touch panel, a capacitive touch panel, an infrared touch panel, and a sound wave touch panel.

The conventional manufacturing of the conventional touch panel entails repeating some complicated processes, namely an exposure process, a development process, an etching process, and a sputtering process, such that a first transparent conductive film, a first electrode, a second transparent conductive film, and a second electrode are stacked on a substrate in sequence to thereby connect the first electrode to the first transparent conductive film and connect the second electrode to the second transparent conductive film. However, if one of the aforesaid processes, namely the exposure process, the development process, the etching process and the sputtering process, goes wrong, the touch panel will get damaged. As a result, the prior art s flawed with low process yield of touch panels.

As the first electrode and the second electrode are formed at different film layers, a double sided soft circuit board is required to connect the first electrode and the second electrode to a driving device. For example, the second electrode is connected to the double sided soft circuit board from above, whereas the first electrode is connected to the double sided soft circuit board from below.

Accordingly, it is imperative to provide a touch panel and a touch panel manufacturing method which are conducive to overcoming the aforesaid drawbacks of the prior art.

### SUMMARY

The first objective of the present invention is to provide a touch panel which enables a dielectric layer to be stacked on a portion of a first conductive layer and thereby simplifies the way of forming a plurality of electrodes in a subsequent manufacturing process.

The second objective of the present invention is to enable the touch panel to be equipped with a flexible substrate and thereby attached to a non-planar surface of an object, such that the touch-controlled operation of the object can be achieved by means of the touch panel.

The third objective of the present invention is to provide the touch panel characterized by the plurality of electrodes with a plurality of film layers extended by a conductive wire and thereby disposed on the same substrate, such that the electrodes are connected by a unilateral soft circuit board.

The fourth objective of the present invention is to provide a touch panel manufacturing method for sputtering a metal onto a first sensing pattern of a first conductive layer and onto a second sensing pattern of a second conductive layer simultaneously so as to form a metal layer at the first sensing pattern and the second sensing pattern simultaneously by a single manufacturing process, thereby simplifying an electrode manufacturing process.

The fifth objective of the present invention is to provide the touch panel manufacturing method for sputtering a metal onto a first conductive layer and a second conductive layer simultaneously and etching the metal to allow the metal to form a first sensing pattern and a second sensing pattern, such that a plurality of electrodes is formed concurrently by a single manufacturing process, thereby simplifying an electrode manufacturing process.

In order to achieve the above and other objectives, the present invention provides a touch panel. The touch panel comprises a substrate, a first conductive layer, a dielectric layer, a second conductive layer and a metal layer. The first conductive layer is stacked on the substrate. The first conductive layer has a first sensing unit, a third sensing unit and a first connecting unit. The first connecting unit is disposed between the first sensing unit and the third sensing unit. The first conductive layer is defined with a first region and a second region. The first region contains a portion of the first sensing unit, and the second region contains the third sensing unit, another portion of the first sensing unit, and the first connecting unit. The dielectric layer is stacked on the third sensing unit of the second region, another portion of the first sensing unit, and the first sensing unit. The second conductive layer is stacked on the dielectric layer. The second conductive layer has a second sensing unit, a fourth sensing unit and a second connecting unit. The second connecting unit is disposed between the second sensing unit and the fourth sensing unit. The metal layer is stacked on the first sensing unit of the first region, so as to form a first electrode at the first sensing unit. The metal layer is stacked on a portion of the second sensing unit, so as to form a second electrode at the portion of the second sensing unit.

(a) In order to achieve the above and other objectives, the present invention provides a touch panel manufacturing method. The manufacturing method comprises the steps described as follows: step (a) providing a substrate; step (b) forming on the substrate a first conductive layer having a first pattern group, the first pattern group comprising a first sensing pattern, a third sensing pattern, and a first connecting pattern, the first connecting pattern connecting the first sensing pattern and the third sensing pattern, wherein the first sensing pattern, the third sensing pattern, and the first connecting pattern are arranged along a first axis; step (c) defining a first region and a second region on the first conductive layer, the first region containing a portion of the first sensing pattern, and the second region containing the third sensing pattern, the other portion of the first sensing pattern, and the first connecting pattern; step (d) forming a dielectric layer on the third sensing pattern of the second region, another portion of the first sensing pattern, and the first connecting pattern; step (e) forming on the dielectric layer a second conductive layer having a second pattern group, the second pattern group having a second sensing pattern, a fourth sensing pattern, and a second connecting pattern connected to the second sensing pattern and the fourth sensing pattern, wherein the second sensing pattern, the fourth sensing pattern, and the second connecting pattern are arranged along a second axis, wherein the second axis and the first axis have an included angle of 90°; and step (f) forming a metal layer at the first sensing pattern of the first region to thereby form a first electrode at the first sensing pattern, form the metal layer at a portion of the second sensing pattern, and form a second electrode at the portion of the second sensing pattern.

Compared with the prior art, the present invention provides a touch panel and a touch panel manufacturing method whereby a dielectric layer is stacked not at a portion of the first conductive layer so as to overcome a drawback of the prior art—intricate processes are required to form a first electrode at the first conductive layer and form a second electrode at the second conductive layer.

The present invention not only simplifies the required processes but also enables the touch panel to be attached to a non-planar surface of an object by means of a flexible substrate.

### BRIEF DESCRIPTION

Objectives, features, and advantages of the present invention are hereunder illustrated with specific embodiments in conjunction with the accompanying drawings, in which:

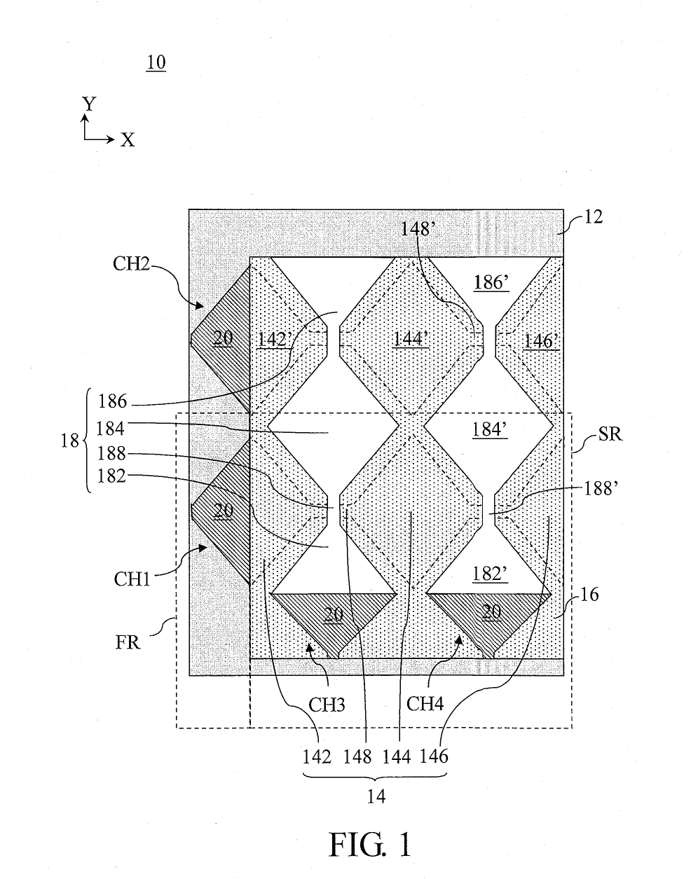

FIG. 1 is a top view of a touch panel according to the first embodiment of the present invention;

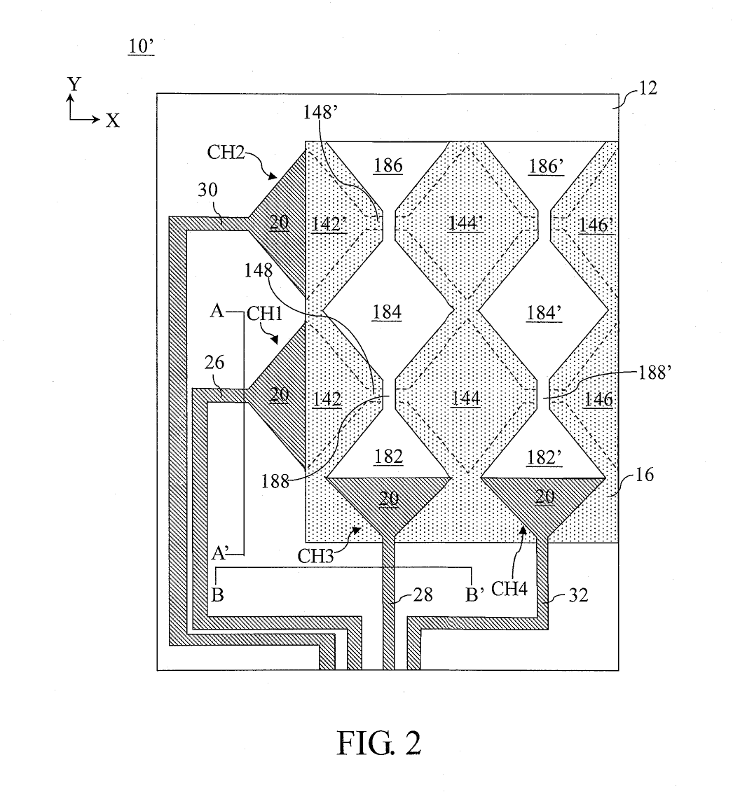

FIG. 2 is a top view of a touch panel according to the second embodiment of the present invention;

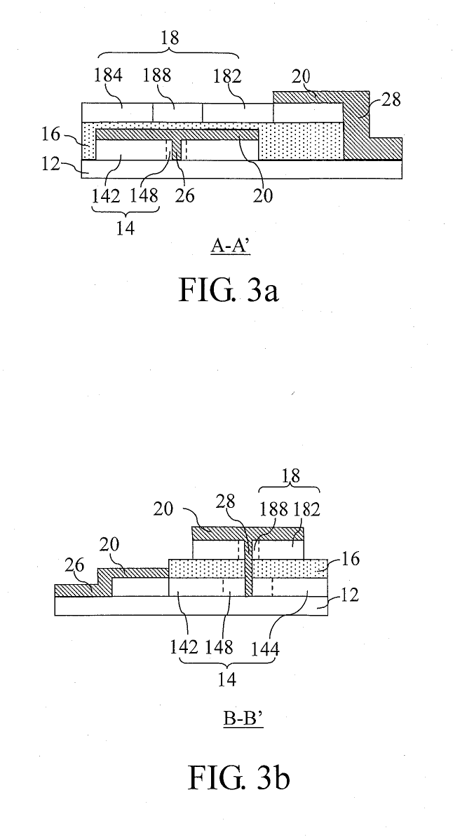

FIG. 3a is a cross-sectional view of the touch panel taken along line A-A′ of FIG. 2 according to the present invention;

FIG. 3b is a cross-sectional view of the touch panel taken along line B-B′ of FIG. 2 according to the present invention;

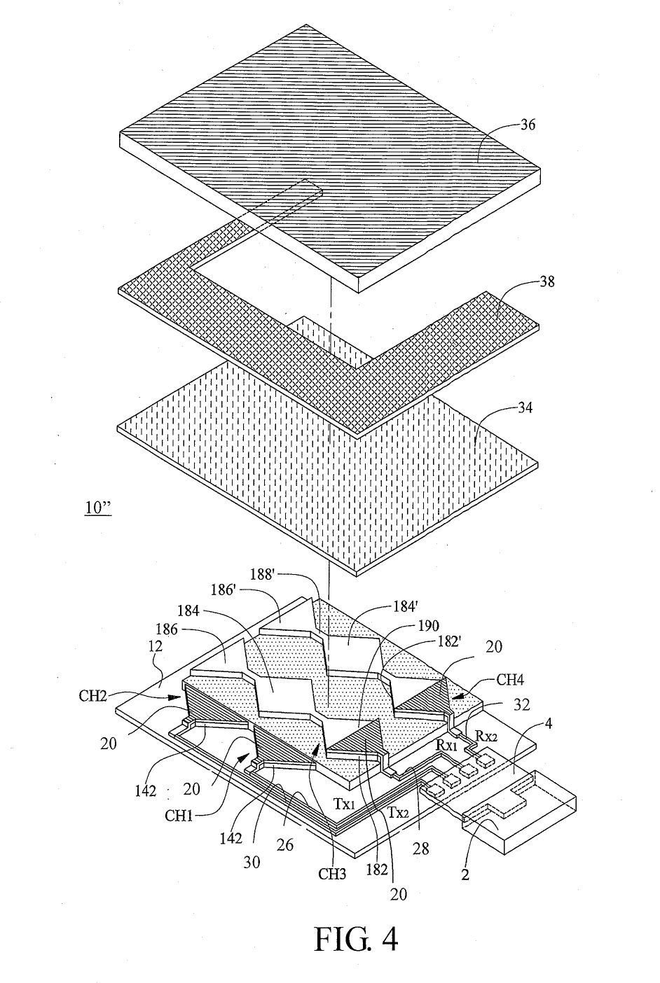

FIG. 4 is a perspective view of the touch panel according to the third embodiment of the present invention;

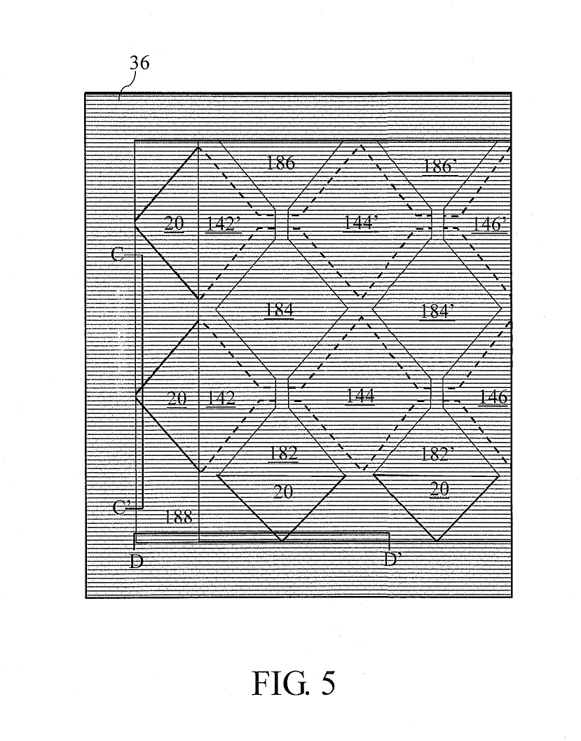

FIG. 5 is a top view of the touch panel according to the third embodiment of the present invention;

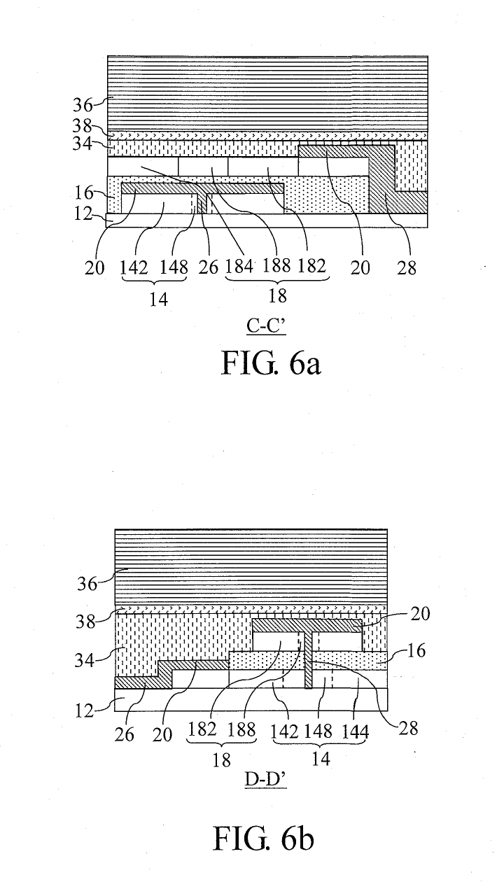

FIG. 6a is a cross-sectional view of the touch panel taken along line C-C′ of FIG. 5 according to the present invention;

FIG. 6b is a cross-sectional view of the touch panel taken along line D-D′ of FIG. 5 according to the present invention;

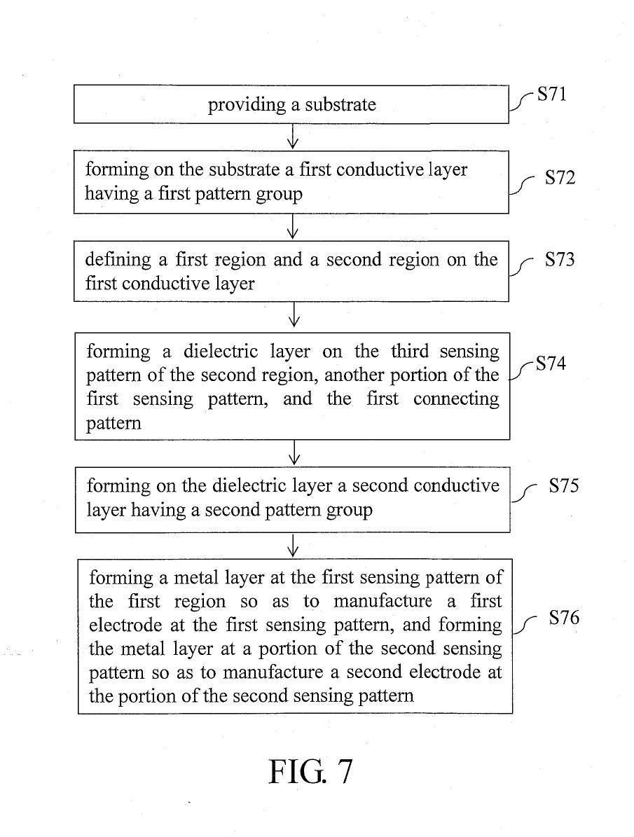

FIG. 7 is a schematic view of the process flow of a touch panel manufacturing method according to the first embodiment of the present invention; and

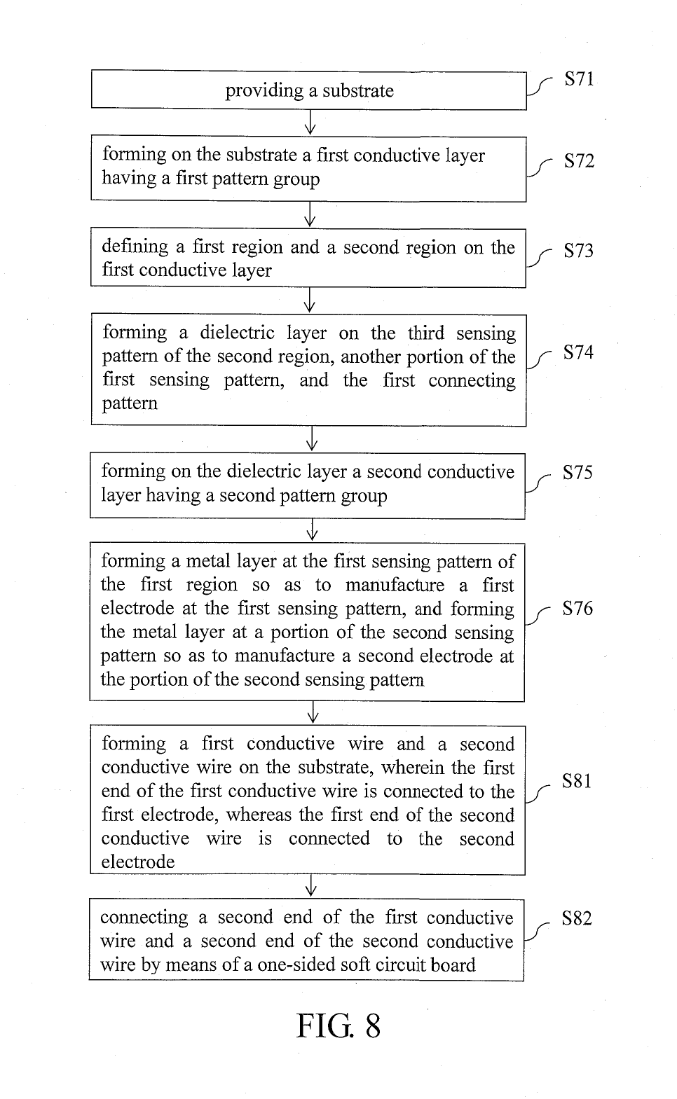

FIG. 8 is a schematic view of the process flow of the touch panel manufacturing method according to the second embodiment of the present invention.

### DETAILED DESCRIPTION

Referring to FIG. 1, there is shown a top view of a touch panel 10 according to the first embodiment of the present invention. As shown in FIG. 1, the touch panel 10 comprises a substrate 12, a first conductive layer 14, a dielectric layer 16, a second conductive layer 18, and a metal layer 20.

The substrate 12 is made of a flexible material or an inflexible material. The substrate 12 is made of silicon dioxide, polyethylene, polypropylene, polyvinyl chloride, polycarbonate, polymethacrylate, and/or polyethylene terephthalate.

The first conductive layer 14 is stacked on the substrate 12. The first conductive layer 14 is made of a transparent conductive material. For example, the transparent conductive material includes indium tin oxide, indium zinc oxide, cadmium tin oxide, aluminum zinc oxide, indium zinc tin oxide, zinc oxide, cadmium oxide, hafnium oxide, indium gallium zinc oxide, indium gallium zinc magnesium oxide, indium gallium oxide, indium gallium aluminum oxide, silver nanowire, graphene, and/or metal mesh.

The first conductive layer 14 comprises a first channel CH1 and a second channel CH2. The first channel CH1 comprises a first sensing unit 142, a third sensing unit 144, a fifth sensing unit 146, and a first connecting unit 148. The first connecting unit 148 is disposed between the first sensing unit 142 and the third sensing unit 144. The first connecting unit 148 is disposed between the third sensing unit 142 and the fifth sensing unit 146. The second channel CH2 comprises another first sensing unit 142′, another third sensing unit 144′, another fifth sensing unit 146′, and another first connecting unit 148′. The way of connecting the sensing units and the connecting units of the second channel CH2 is the same as the way of connecting the sensing units and the connecting units of the first channel CH1.

Each of the sensing units of the first channel CH1 is rhomboidal, triangular, rectangular, and/or round. Each of the sensing units of the second channel CH2 is rhomboidal, triangular, rectangular, and/or round. In this embodiment, the sensing units are rhomboidal for illustrative purpose. The sensing units can be in the number of one, two, or multiple. In this embodiment, the sensing units are in the number of six for he sake of illustration.

As the composition and configuration of the second channel CH2 are the same as that of the first channel CH1, persons skilled in the art can gain insight into the composition and configuration of the first channel CH1 by making reference to the description of the second channel CH2 below.

The first sensing unit 142, the third sensing unit 144, the fifth sensing unit 146 and the first connecting unit 148 are arranged along a first axis. In this embodiment, the first axis is indicated by X-axis shown in FIG. 1.

The first conductive layer 14 is defined with a first region FR and a second region SR. The first region FR contains a half of the first sensing unit 142. The second region SR contains the other half of the first sensing unit 142, the third sensing unit 144, the fifth sensing unit 146, and the first connecting unit 148.

The dielectric layer 16 is stacked on the first sensing unit 142 of the second region SR of the first conductive layer 14, the third sensing unit 144, the fifth sensing unit 146, and the first connecting unit 148. The dielectric layer 16 electrically insulates the first conductive layer 14 from the second conductive layer 18.

The second conductive layer 18 is stacked on the dielectric layer 16. The second conductive layer 18 is made of a transparent conductive material including all the options mentioned in the above description of the first conductive layer 14.

The second conductive layer 18 comprises a third channel CH3 and a fourth channel CH4. The third channel CH3 comprises a second sensing unit 182, a fourth sensing unit 184, a sixth sensing unit 186, and a second connecting unit 188. The second connecting unit 188 is disposed between the second sensing unit 182 and the fourth sensing unit 184. The second connecting unit 188 is disposed between the fourth sensing unit 182 and the sixth sensing unit 184. The fourth channel CH4 comprises another second sensing unit 182′, another fourth sensing unit 184′, another sixth sensing unit 186′, and another second connecting unit 188′. The way of connecting the sensing units and the connecting units of the fourth channel CH4 is the same as the way of connecting the sensing units and the connecting units of the third channel CH3.

Each of the sensing units of the third channel CH3 is rhomboidal, triangular, rectangular, and/or round. Each of the sensing units of the fourth channel CH4 is rhomboidal, triangular, rectangular, and/or round. In this embodiment, the sensing units are rhomboidal for illustrative purpose. The sensing units can be in the number of one, two, or multiple. In this embodiment, the sensing units are in the number of six for the sake of illustration.

As the composition and configuration of the fourth channel CH4 are the same as that of the third channel CH3, persons skilled in the art can gain insight into the composition and configuration of the fourth channel CH4 by making reference to the description of the third channel CH3 below.

The second sensing unit 182, the fourth sensing unit 184, the sixth sensing unit 186, and the second connecting unit 188 are arranged along a second axis. In this embodiment, the second axis is indicated by Y-axis shown in FIG. 1.

With the first axis and the second axis being X-axis and Y-axis, respectively, the included angle between the first axis and the second axis in this embodiment equals 90°.

The metal layer 20 is stacked on the first sensing units 142, 142′ of the first region FR, so as to form a first electrode at the first sensing units 142, 142′ each. The metal layer 20 is stacked on a half of the second sensing units 182, 182′ each, so as to form a second electrode at a half of the second sensing units 182, 182′ each.

In another embodiment, the first electrode is of an area no greater than that of one of the first sensing units 142, 142′, and the second electrode is of an area no greater than that of one of the second sensing units 182, 182′.

Referring to FIG. 2, there is shown a top view of a touch panel 10′ according to the second embodiment of the present invention. As shown in FIG. 2, the touch panel 10′ not only comprises all the layers of the first embodiment, but also comprises a first conductive wire 26, a second conductive wire 28, a third conductive wire 30, and a fourth conductive wire 32.

A first end 262 of the first conductive wire 26 is connected to the first electrode of the first channel CH1, so as for the first electrode to be extended by means of the first conductive wire 26. By analogy, connection of the other electrodes to the conductive wires produces the aforesaid result as well.

At least three ways of manufacturing the first conductive wire 26, the second conductive wire 28, the third conductive wire 30, and the fourth conductive wire 32 are described as follows:

A screen printing process is performed on the substrate 12 to form the first conductive wire 26, the second conductive wire 28, the third conductive wire 30 and the fourth conductive wire 32 on the substrate 12.

A metal sputtering process, an exposure process, a development process, and an etching process are performed on the substrate 12 to form the first conductive wire 26, the second conductive wire 28, the third conductive wire 30, and the fourth conductive wire 32 on the substrate 12.

A screen printing process, an exposure process, and a development process are performed on the substrate 12 by way of a metal layer to form the first conductive wire 26, the second conductive wire 28, the third conductive wire 30 and the fourth conductive wire 32 on the substrate 12.

The first electrode 22 receives or sends a control signal (not shown) by means of the first conductive wire 26. By analogy, the other electrodes receive or send the control signal by means of a conductive wire. If the first electrodes 22, 22′are configured to receive the control signal, the second electrodes 24, 24′ will be configured to send the control signal, and vice versa.

Referring to FIG. 3a, there is shown a cross-sectional view of the touch panel taken along line A-A′ of FIG. 2 according to the present invention. Referring to FIG. 3b, there is shown a cross-sectional view of the touch panel taken along line B-B′ of FIG. 2 according to the present invention.

Referring to FIG. 4, there is shown a perspective view of a touch panel 10″ according to the third embodiment of the present invention. As shown in FIG. 4, the touch panel 10″ comprises a substrate 12, a first conductive layer 14, a dielectric layer 16, a second conductive layer 18, a metal layer 20, a first conductive wire 26, a second conductive wire 28, a third conductive wire 30, a fourth conductive wire 32, an adhesive layer 34, a protective layer 36, and a decorative layer 38. Barring the adhesive layer 34, the protective layer 36 and the decorative layer 38, the above-mentioned is described in the descriptions of the first embodiment and the second embodiment.

As mentioned before, the first conductive wire 26, the second conductive wire 28, the third conductive wire 30 and the fourth conductive wire 32 are disposed on the substrate 12, and thus the conductive wires are connected to a driving unit 2 by means of a one-sided soft circuit board 4 to thereby receive the control signal from the driving unit 2 or send the control signal to the driving unit 2.

In this embodiment, Tx1 indicates that the control signal is sent from the first channel CH1 to the one-sided soft circuit board 4 by means of the first conductive wire 26, and Tx2 indicates that the control signal is sent from the second channel CH2 to the one-sided soft circuit board 4 by means of the third conductive wire 30. Rx1 indicates that the control signal from the one-sided soft circuit board 4 is received by means of the second conductive wire 28 and sent to the third channel CH3, whereas Rx2 indicates that the control signal from the one-sided soft circuit board 4 is received by means of the fourth conductive wire 32 and sent to the fourth channel CH4.

The adhesive layer 34 is stacked on the dielectric layer 16, the second conductive layer 18, the metal layer 20, the first conductive wire 26, the second conductive wire 28, the third conductive wire 30 and the fourth conductive wire 32. For example, the adhesive layer 34 is made from an optical adhesive of high optical penetration.

The protective layer 36 is stacked on the adhesive layer 34. For example, the protective layer 36 is made of a transparent material. The protective layer 36 can be touched directly by users, and still the first conductive layer 14 and the second conductive layer 18 are protected against damaged. The protective layer 36 is adhered to the second conductive layer 18 by means of the adhesive layer 34. The rigidity of the protective layer 36 is higher than that of the two conductive layers 18. The protective layer 36 is made of a flexible material or an inflexible material. For example, the protective layer 36 is made of silicon dioxide, polyethylene, polypropylene, polyvinyl chloride, polycarbonate, polymethacrylate, and/or polyethylene terephthalate.

As the substrate 12 and the protective layer 36 are made of a flexible material, the touch panel 10″ is applicable to any object with a non-planar surface, such as curved surface or round surface.

The decorative layer 38 is disposed between the adhesive layer 34 and the protective layer 36. The decorative layer 38 is made of different opaque materials, such as ink. As the substrate 12 has thereon the first conductive wire 26, the second conductive wire 28, the third conductive wire 30 and the fourth conductive wire 32, a user watching the touch panel in the direction from the protective layer 36 to the substrate 12 seldom finds the touch panel good-looking because of the conductive wire 32. Hence, with the decorative layer 38 hiding the conductive wire, the user cannot see the conductive wires. Referring to FIG. 5, there is shown a top view of the touch panel 10″. As shown in FIG. 5, in the presence of the protective layer 36, the user does not see the conductive wire.

Referring to FIG. 6a, there is shown a cross-sectional view of the touch panel taken along line C-C′ of FIG. 5 according to the present invention. Referring to FIG. 6b, there is shown a cross-sectional view of the touch panel taken along line D-D′ of FIG. 5 according to the present invention. Referring to FIG. 7, there is shown a schematic view of the process flow of a touch panel manufacturing method according to the first embodiment of the present invention. As shown in FIG. 7, the manufacturing method comprises the steps described below.

Step S71: providing a substrate.

Step S72: forming on the substrate a first conductive layer having a first pattern group.

The first pattern group comprises a first sensing pattern, a third sensing pattern and a first connecting pattern. The first connecting pattern is connected to the first sensing pattern and the third sensing pattern. The first sensing pattern, the third sensing pattern, and the first connecting pattern are arranged along a first axis. In this step, for example, a metal sputtering process, an exposure process, a development process and an etching process are performed to manufacture the first sensing pattern, the third sensing pattern and the first connecting pattern. Alternatively, a transparent conductive film is adhered onto the substrate, and then an exposure process, a development process and an etching process are performed on the transparent conductive film to manufacture the first sensing pattern, the third sensing pattern, and the first connecting pattern.

Step S73: defining a first region and a second region on the first conductive layer. The first region contains a portion of the first sensing pattern, and the second region contains the third sensing pattern, the other portion of the first sensing pattern, and the first connecting pattern.

Step S74: forming a dielectric layer on the third sensing pattern of the second region, another portion of the first sensing pattern, and the first connecting pattern.

Step S75: forming on the dielectric layer a second conductive layer having a second pattern group. The second pattern group has a second sensing pattern, a fourth sensing pattern, and a second connecting pattern. The second connecting pattern is connected to the second sensing pattern and the fourth sensing pattern. The third sensing pattern, the fourth sensing pattern, and the second connecting pattern are arranged along a second axis, for example, the second axis and the first axis have an included angle of 90°. In this step, a metal sputtering process, an exposure process, a development process, and an etching process are performed to manufacture the second sensing pattern, the fourth sensing pattern, and the second connecting pattern. Alternatively, a transparent conductive film is adhered onto the substrate, and then an exposure process, a development process, and an etching process are performed on the transparent conductive film to manufacture the second sensing pattern, the fourth sensing pattern, and the second connecting pattern.

Step S76: forming a metal layer at the first sensing pattern of the first region so as to manufacture a first electrode at the first sensing pattern, and forming the metal layer at a portion of the second sensing pattern so as to manufacture a second electrode at the portion of the second sensing pattern.

Referring to FIG. 8, there is shown a schematic view of the process flow of the touch panel manufacturing method according to the second embodiment of the present invention. As shown in FIG. 8, in addition to step S71 through step S76, the manufacturing method further comprises step S81 and step S82.

In step S81 which follows step S76, the substrate forms a first conductive wire and a second conductive wire, wherein the first end of the first conductive wire is connected to the first electrode, whereas the first end of the second conductive wire is connected to the second electrode. The way of forming the first conductive wire and the second conductive wire is the same as the way of forming the first conductive wire 26, the second conductive wire 28, the third conductive wire 30 and the fourth conductive wire 32 (see paragraph [0045]).

In another embodiment, it is feasible for the step S81 to be integrated into step S76. Hence, in step S76, as soon as a portion of the first sensing pattern forms the metal layer, the metal layer forms the first conductive wire at the substrate; by analogy, the metal layer forms the second conductive wire at the substrate.

The step S82, which follows step S81, involves connecting a second end of the first conductive wire and a second end of the second conductive wire by means of a one-sided soft circuit board.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A touch panel, comprising:
a substrate;
a first conductive layer stacked on the substrate and having a first sensing unit, a third sensing unit and a first connecting unit disposed between the first sensing unit and the third sensing unit, wherein the first conductive layer is defined with a first region and a second region, the first region containing a portion of the first sensing unit, and the second region containing the third sensing unit, another portion of the first sensing unit, and the first connecting unit;
a dielectric layer stacked on the third sensing unit of the second region, another portion of the first sensing unit, and the first connecting unit;
a second conductive layer stacked on the dielectric layer and having a second sensing unit, a fourth sensing unit, and a second connecting unit disposed between the second sensing unit and the fourth sensing unit; and
a metal layer stacked on the first sensing unit of the first region to form a first electrode at the first sensing unit and stacked on a portion of the second sensing unit to form a second electrode at the portion of the second sensing unit.

2. The touch panel of claim 1, wherein the first electrode is of an area no greater than that of the first sensing unit, and the second electrode is of an area no greater than that of the second sensing unit.

3. The touch panel of claim 1, wherein the first sensing unit, the third sensing unit and the first connecting unit are arranged along a first axis, and the second sensing unit, the fourth sensing unit and the second connecting unit are arranged along a second axis.

4. The touch panel of claim 3, wherein the first axis and the second axis form an included angle of 90°.

5. The touch panel of claim 1, further comprising a first conductive wire having a first end connected to the first electrode and a second conductive wire having a first end connected to the second electrode, wherein a one-sided soft circuit board is connected to a second end of the first conductive wire and a second end of the second conductive wire.

6. The touch panel of claim 5, further comprising an adhesive layer stacked on the first sensing unit of the first region, the first conductive wire, the second conductive wire, the dielectric layer, the second conductive layer, and the metal layer, and made from a transparent optical adhesive.

7. The touch panel of claim 6, further comprising protective layer stacked on the adhesive layer and made of a transparent material.

8. The touch panel of claim 7, further comprising a decorative layer disposed between the adhesive layer and the protective layer and made of an opaque material.

9. The touch panel of claim 1, wherein the first sensing unit, the third sensing unit, the second sensing unit, and the fourth sensing unit are rhomboidal, triangular, rectangular, and/or round each.

10. The touch panel of claim 1, wherein the first conductive layer and the second conductive layer are each made of a transparent conductive material comprising at least one selected from the group consisting of indium tin oxide, indium zinc oxide, cadmium tin oxide, aluminum zinc oxide, indium zinc tin oxide, zinc oxide, cadmium oxide, hafnium oxide, indium gallium zinc oxide, indium gallium zinc magnesium oxide, indium gallium oxide, indium gallium aluminum oxide, silver nanowire, graphene, and metal mesh.

11. The touch panel of claim 1, wherein the substrate is made of at least one of silicon dioxide, polyethylene, polypropylene, polyvinyl chloride, polycarbonate, polymethacrylate, and polyethylene terephthalate.

12. The touch panel of claim 1, wherein the substrate is made of a flexible material.

13. A touch panel manufacturing method, comprising the steps of:
(b) providing a substrate;
(c) forming on the substrate a first conductive layer having a first pattern group, the first pattern group comprising a first sensing pattern, a third sensing pattern, and a first connecting pattern, the first connecting pattern connecting the first sensing pattern and the third sensing pattern, wherein the first sensing pattern, the third sensing pattern, and the first connecting pattern are arranged along a first axis;
(d) defining a first region and a second region on the first conductive layer, the first region containing a portion of the first sensing pattern, and the second region containing the third sensing pattern, the other portion of the first sensing pattern, and the first connecting pattern;
(e) forming a dielectric layer on the third sensing pattern of the second region, another portion of the first sensing pattern, and the first connecting pattern;
(f) forming on the dielectric layer a second conductive layer having a second pattern group, the second pattern group having a second sensing pattern, a fourth sensing pattern, and a second connecting pattern connected to the second sensing pattern and the fourth sensing pattern, wherein the second sensing pattern, the fourth sensing pattern, and the second connecting pattern are arranged along a second axis, wherein the second axis and the first axis have an included angle of 90°; and
(g) forming a metal layer at the first sensing pattern of the first region to thereby form a first electrode at the first sensing pattern, form the metal layer at a portion of the second sensing pattern, and form a second electrode at the portion of the second sensing pattern.

14. The touch panel manufacturing method of claim 13, wherein step (b) involves one of forming the first sensing pattern, the third sensing pattern, and the first connecting pattern by a metal sputtering process, an exposure process, a development process, and an etching process and adhering a transparent conductive film onto the substrate before performing an exposure process, a development process and an etching process on the transparent conductive film to form the first sensing pattern, the third sensing pattern, and the first connecting pattern.

15. The touch panel manufacturing method of claim 13, wherein step (e) involves one of forming the second sensing pattern, the fourth sensing pattern, and the second connecting pattern by a metal sputtering process, an exposure process, a development process, and an etching process and adhering a transparent conductive film onto the substrate before performing an exposure process, a development process, and an etching process on the transparent conductive film to form the second sensing pattern, the fourth sensing pattern, and the second connecting pattern.

16. The touch panel manufacturing method of claim 13, wherein, in step (f), a first conductive wire and a second conductive wire are stacked by means of the metal layer to thereby connect a first end of the first conductive wire to the first electrode and connect a first end of the second conductive wire to the second electrode.

17. The touch panel manufacturing method of claim 13, wherein step (g) follows step (f) and involves forming on the substrate a first conductive wire and a second conductive wire to thereby connect a first end of the first conductive wire to the first electrode and connect a first end of the second conductive wire to the second electrode.

18. The touch panel manufacturing method of claim 17, wherein step (h) follows step (g) and involves connecting a second end of the first conductive wire and a second end of the second conductive wire by a one-sided soft circuit board.
